(19) United States
(12) Patent Application Publication
(10) Pub. No.: US 2016/0370927 A1
(43) Pub. Date: Dec. 22, 2016

(54) PORTABLE APPARATUS

(71) Applicants: BOE TECHNOLOGY GROUP CO., LD., Beijing (CN); HEFEI XINSHENG OPTOELECTRONICS TECHNOLOGY CO., LTD., Anhui (CN)

(72) Inventors: Zhixiang FANG, Beijing (CN); Ming HU, Beijing (CN)

(73) Assignees: BOE Technology Group Co., Ltd., Beijing (CN); HEFEI Xinsheng Optpelectronics Technology Co.,Ltd., Anhui (CN)

(21) Appl. No.: 15/122,164

(22) PCT Filed: Mar. 20, 2015
(86) PCT No.: PCT/CN2015/074726

§ 371 Date: Aug. 27, 2016

(30) Foreign Application Priority Data
Nov. 14, 2014 (CN) 201410654246.0

(51) Int. Cl. G06F 3/041; G06F 1/16; G06F 3/0354; G06F 3/0488

(52) U.S. Cl. CPC G06F 3/0416; G06F 3/04886; G06F 1/1613; G06F 3/03547; G06F 1/166; G06F 2203/04103

(57) ABSTRACT

Embodiments of the present invention disclose a portable apparatus. The portable apparatus includes a mainframe body, and a display that is coupled to the mainframe body and is configured to be openable/closable at an angle relative to the mainframe body; wherein, a touch pad and a mode switching key are provided on the mainframe body and a motherboard is provided within the mainframe body, a projecting lens is provided at a frame of the display, and, the touch pad, the mode switching key and the projection lens are coupled to the motherboard; according to a operation mode switched by the mode switching key, the projection lens is configured to project a virtual keyboard onto the touch pad in a keyboard mode and/or to project an image displayed on the display onto the touch pad in the touch-screen mode; and the motherboard is configured to process the touch signal in line with a specified keyboard layout in the keyboard mode and control the touch pad to function as a conventional mechanical keyboard; and/or, to process the touch signal according to contents of the screen image displayed on the display screen in the touch-screen mode and control the touch pad to enable a screen touch control.

### BACKGROUND

1. Technical Field

Embodiments of the present invention relates to the field of computer manufacturing technology, and particularly to a portable apparatus.

2. Description of the Related Art

Portable apparatus has been widely used due to its small volume and convenient portability. The portable apparatus is generally composed of a display, a mainframe body and a keyboard and a mouse control panel that are located on the mainframe body, and the like.

Portable apparatus with touch-controlled function is rapidly developing with the increasing demands on the portable apparatus and considerations of ease to use. For example, a display of a portable apparatus includes a display screen and a touch pad attached to the display screen, in which the display screen is attached to the touch pad by an optical adhesive. The touch pad is coupled to a motherboard by a flexible printed circuit board (FPC) such that a touch signal produced by the touch pad is processed by a processor of the motherboard to achieve a touch-controlled function. FIG. 1 illustrates a prior art portable apparatus having a touch-controlled function, which includes a mainframe body 1 having a front housing 11 and a rear housing 12 and a display 2. An integrally-formed touch pad 24 is attached to a light-emitting side of a display screen (which is covered by the integrally-formed touch pad 24 and thus is not shown) of the display 2. The front housing 11 of the mainframe body 1 is provided with a common mechanical keyboard 3 and a mouse control panel 4. In the portable apparatus as shown in FIG. 1, a touch-controlled operation to an image displayed on the display screen may be achieved by means of the integrally-formed touch pad 24.

However, the prior art portable apparatus has the following problems when implementing the abovementioned touch-controlled function: it has relatively high manufacture difficulty and low yield as the attachment between the touch pad and the display screen is achieved in manner of hardware.

### SUMMARY

According to embodiments of the present invention, there provides a portable apparatus comprising a mainframe body, and a display that is coupled to the mainframe body and is configured to be openable/closable at an angle relative to the mainframe body; wherein, a touch pad and a mode switching key are provided on the mainframe body and a motherboard is provided within the mainframe body, a projection lens is provided at a frame of the display, and, the touch pad, the mode switching key and the projection lens are coupled to the motherboard;

the mode switching key is configured to switch operation modes of the motherboard and the projection lens, the operation modes comprising a keyboard mode and a touch-screen mode;

the touch pad is configured to detect a touch action and generate a touch signal;

the projection lens is configured to project a virtual keyboard onto the touch pad in the keyboard mode, and/or to project an image displayed on the display onto the touch pad in the touch-screen mode; and

the motherboard is configured to process the touch signal in line with a specified keyboard layout in the keyboard mode and control the touch pad to function as a conventional mechanical keyboard; and/or, to process the touch signal according to contents of the screen image displayed on the display in the touch-screen mode and control the touch pad to enable a screen touch control.

### BRIEF DESCRIPTION OF THE DRAWINGS

FIG. 1 is a structural schematic view of a portable apparatus having a touch-controlled function in prior art;

FIG. 2 is a structural schematic view of a portable apparatus according to an embodiment of the present invention;

FIG. 3 is a schematic cross-section view of the portable apparatus as shown in FIG. 2, along a line AB;

FIG. 4 is a structural schematic view of another portable apparatus according to an embodiment of the present invention;

FIG. 5 is a schematic view of a projection of the portable apparatus as shown in FIG. 2 in a keyboard mode;

FIG. 6 is a schematic view of a projection of the portable apparatus as shown in FIG. 2 in a touch-screen mode; and

FIG. 7 is a schematic view of a projection of the portable apparatus as shown in FIG. 4 in a keyboard mode.

### DETAILED DESCRIPTION OF THE EMBODIMENTS

A further description of the invention will be made in detail as below with reference to embodiments of the present invention taken in conjunction with the accompanying drawings. It is noted that the same or similar reference number throughout represents the same or similar component or element or components or elements have the same or similar function in the following description. The following embodiments described with the accompanying drawings are exemplary and are intended to explain the present invention, and the present invention should not be construed as being limited to the embodiment set forth herein.

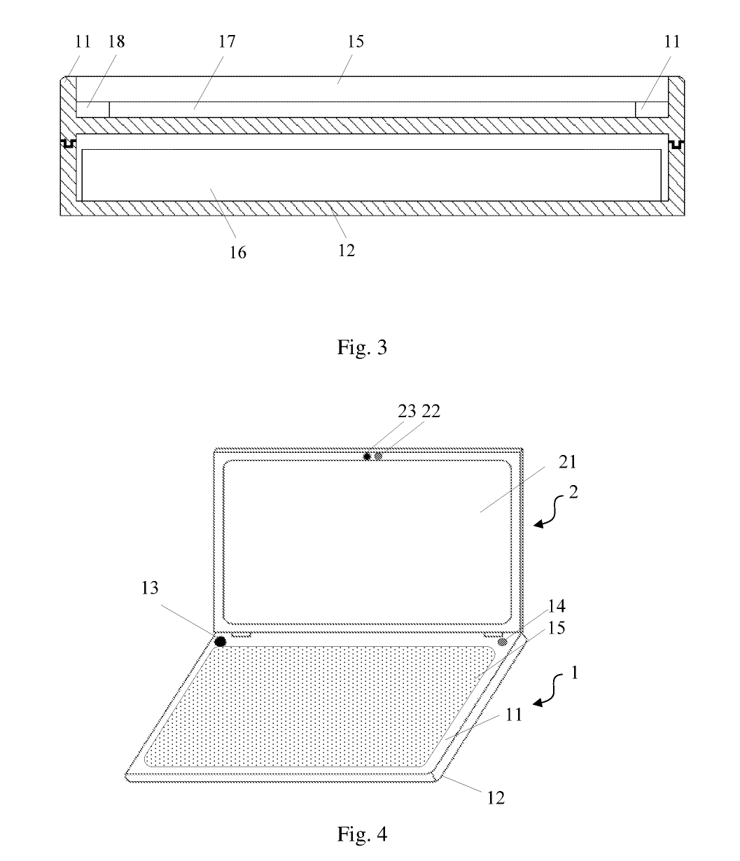

A portable apparatus according to embodiments of the present invention is described in conjunction with FIGS. 2 and 3. The portable apparatus comprises a mainframe body 1 and a display 2. The mainframe body 1 comprises a front housing 11. In an implementation, the mainframe body 1 may only comprise the front housing 11. In another implementation, the mainframe body 1 may not only comprise the front housing 11 but also comprise a rear housing 12, and, the front housing 11 and the rear housing 12 jointly constitute a housing of the mainframe body 1. In the embodiment as shown in FIGS. 2 and 3, the mainframe body 1 comprises the front housing 11 and the rear housing 12.

In an embodiment of the present invention, the mainframe body 1 further comprises a motherboard 16. As shown in FIG. 3, the motherboard 16 is arranged in the rear housing 12.

In an embodiment of the present invention, the front housing 11 of the mainframe body 1 is provided with a mode switching key 14 and a touch pad 15, and the display 2 comprises a display screen 21. The mainframe body 1 may further comprise a start-up key 13 arranged a region of the front housing 11 outside the touch pad 15, for example, it is arranged in the front housing 11 (as shown in FIGS. 2 and 3), or it is arranged in a frame of the mainframe body 1.

The mode switching key 14, the touch pad 15 and a projection lens 22 are coupled to the motherboard 16. Specifically, the electrical couplings may be achieved using a flexible board or other connection line. The mode switching key 14, the touch pad 15 and the projection lens 22 may be further in connection with a processor (not shown) in the motherboard 16 so as to achieve controls of the mode switching key 14, the touch pad 15 and the projection lens 22 by the motherboard 16. The processor may be a processor broadly defined. Moreover, a plurality of processors may be provided to be coupled to the mode switching key 14, the touch pad 15 and the projection lens 22, respectively. Alternatively, only one processor may be provided to be coupled to the mode switching key 14, the touch pad 15 and the projection lens 22. For example, the mode switching key 14, the touch pad 15 and the projection lens 22 are all coupled to a central processing unit (CPU) so as to achieve a unified control. As another example, a touch-controlled processor is provided to be coupled to the mode switching key 14 and the touch pad 15 while a display processor is provided to be coupled to the projection lens 22. There are other similar configurations and will be not described in detailed.

The mode switching key 14 is configured to switch operation modes of the motherboard 16 and the projection lens 22, and the operation modes comprise a keyboard mode and a touch-screen mode. The touch pad 15 is configured to detect a touch action and generate a touch signal. The projection lens 22 is configured to project an image that is matched with the current operation mode onto the touch pad 15 and/or to match a projection area on the touch pad 15 with an area of the touch pad 15. The motherboard 16 is configured to process the touch signal according to the operation mode. Specifically, the touch pad 15 may function as a conventional mechanical keyboard in the keyboard mode, while it may have a touch-controlled function in the touch-screen mode. According to an embodiment of the present invention, by providing the mode switching key 14 and the touch pad 15 in the mainframe body 1 of the portable apparatus, the mode switching key 14 may achieve the switch between the keyboard mode and the touch-screen mode and the projection lens may accordingly project the image that is matched with the keyboard mode or the touch-screen mode onto the touch pad. Meanwhile, the touch signals in different modes may be processed by the motherboard 16, so as to achieve a keyboard function or a screen image touch-controlled function.

A projection of the projection lens 22 towards the touch pad 15 will be described as below in detail.

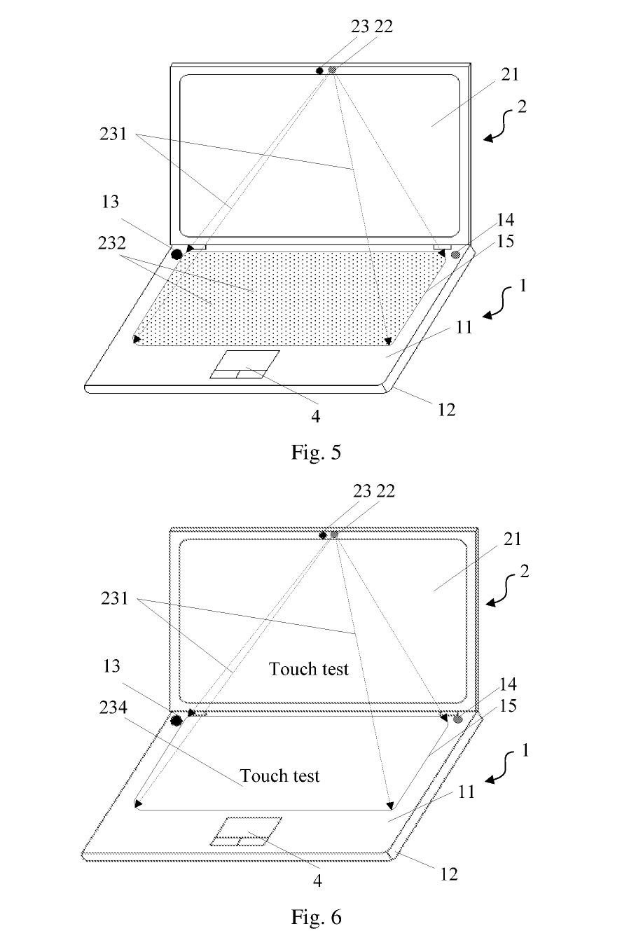

The projection lens 22 projects a virtual keyboard to the touch pad 15 in the keyboard mode, such as the virtual keyboard 232 as shown in FIG. 5, while the projection lens 22 projects an image displayed on the display to the touch pad 15 in the touch-screen mode, such as a projected screen image 234 as shown in FIG. 6. In these embodiments, the projection lens 22 may project the virtual keyboard 232 and the screen image 234 respectively in different operation modes, so as to achieve a visual keyboard operation or a touch-controlled operation by operating on the image projected on the touch pad 15.

According to different operation modes, the motherboard 16 may provide a touch signal processing function that matches with the different operation modes.

The motherboard 16 processes the touch signal in line with a specified keyboard layout in the keyboard mode while processes the touch signal according to a screen image content displayed on the screen 21 of the display 2 in the touch-screen mode. It can be seen that, in these embodiments, the motherboard 16 may provide suitable signal processing manners for different operation modes, so as to achieve the keyboard function or the screen image touch-controlled function. Specifically, in the keyboard mode, the motherboard 16 selectively processes a signal produced by the touch pad 15 in line with the keyboard layout. For example, coordinate ranges of keys of the keyboard may be preset so as to detect whether the received touch signal is an effective keyboard touch signal or not based on the coordinate ranges. In the screen image mode, the motherboard 16 may make an entire correspondence between the touch pad 15 and the display screen 21, so as to process the touch signal produced by the touch pad 15 based on the correspondence of coordinate of a pixel of the screen image displayed in the display screen 21.

In addition, effect of a projection of the projection lens 22 may be affected as, for example, a projected image goes beyond an effective area of the touch pad, when a openable/closable angle of the display 2 relative to the mainframe body 1 of the portable apparatus is changed. In this situation, it is necessary to modify the projection of the projection lens 22. The motherboard 16 is further configured to control the projection lens 22 to perform a projection after changing a projection angle or zooming in/out the screen image by the processor, such that the projection area of the screen image on the touch pad 15 matches with the area of the touch pad 15. For example, when the openable/closable angle of the display 2 relative to the mainframe body 1 is changed, the motherboard 16 controls the projection lens 22 to perform a projection after changing a projection angle or zooming in/out the screen image by the processor so as to match with the area of the touch pad 15. A way of detecting the opened/closed angle may be specifically to detect an angle of a rotating axis between the mainframe body 1 and the display 2, or to provide a sensor on the mainframe body 1 and/or the display 2 to detect the opened/closed angle therebetween. In an embodiment of the present invention, the projection lens 22 may be configured to always project exactly the projected image within the region of the touch pad 15.

In order to buffer a force suffered by the touch pad when the touch pad receiving the touch action, to decrease damage to the touch pad, preferably, the mainframe body 1 according to the embodiment may further include a buffer pad 17 as shown in FIG. 3. The buffer pad 17 is arranged between the front housing 11 and the touch pad 15.

The front housing 11 and the touch pad 15 may be combined by an adhesive tape 18. In an embodiment of the present invention, attachment of the front housing 11 and the touch pad 15 is achieved using an adhesive tape 18 with a lower value, thereby reducing the cost.

Preferably, the portable apparatus further includes a camera 23 which is arranged at an upper frame of the display 2.

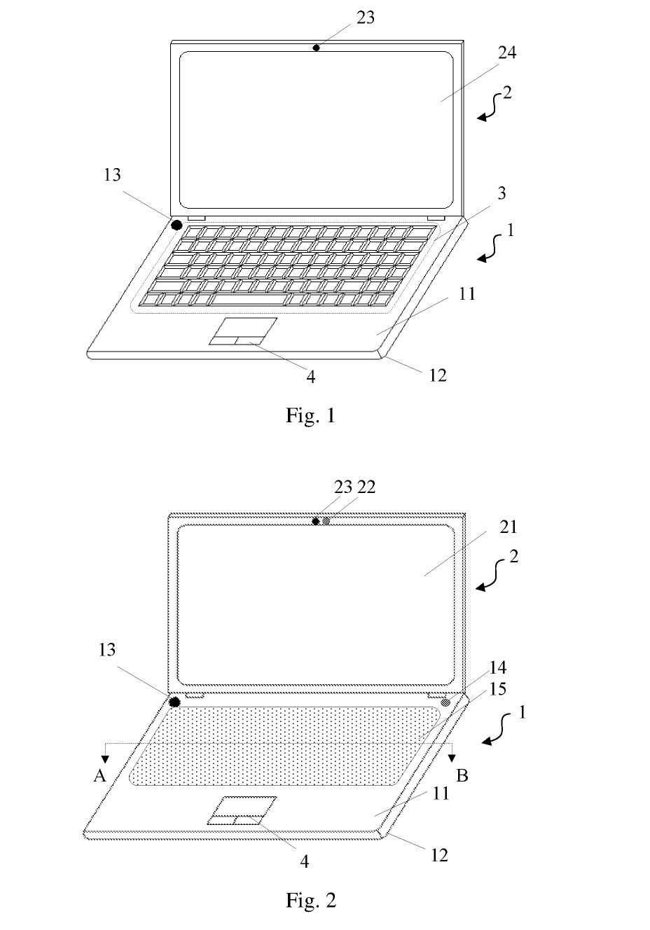

It is noted that the area of the touch pad 15 is preferably at least larger than or equal to an area of a conventional mechanical keyboard, and the conventional mechanical keyboard is not merely directed to a specific mechanical keyboard or a mechanical keyboard with a fixed area or a mechanical keyboard in standard size, and on the contrary, may be various mechanical keyboards that may be disposed at the front housing 11 of various portable apparatuses. In a conventional portable apparatus as shown in FIG. 1, the front housing 11 is provided with a mouse control panel 4, in additional to the mechanical keyboard 3. Base on different requestments, the portable apparatus according to the embodiment may be provided with the mouse control panel 4 as shown in FIG. 1 or may be also configured to have a touch pad 15 that covers a region where the mechanical keyboard 3 and the mouse control panel 4 are located. For example, in the embodiment of the portable apparatus as shown in FIG. 2, the touch pad 15 merely covers a region where the conventional mechanical keyboard 3 as shown in FIG. 1 is located while the front housing 11 of the portable apparatus is further provided with the mouse control panel 4. As another example, in the embodiment of the portable apparatus as shown in FIG. 4, the portable apparatus includes the mainframe body 1 and the display 2. The mainframe body 1 includes the front housing 11 and the rear housing 12, and the front housing 11 is provided with the start-up key 13, the mode switching key 14 and the touch pad 15 attached to the front housing 11. The display 2 includes the display screen 21, and the projection lens 22 and the camera 23 disposed at the frame of the display 2. In the embodiment, the touch pad 15 covers the region where the conventional mechanical keyboard 3 and the mouse control panel 4 are located. In addition, according to the embodiments, size of a virtual keyboard projected on the touch pad 15 may be exactly equal to size of the conventional mechanical keyboard. Also, the size of the virtual keyboard may be zoomed in/out according to the area of the touch pad 15. Further, the projection of the screen image may also be zoomed in/out according to the area of the touch pad 15.

In order to provide more exactly understanding on the keyboard mode and the touch-screen mode of the portable apparatus according to the embodiments of the present invention, the projections on the touch pad 15 in the above two operation modes are described as below.

Referring to FIG. 5, a schematic view of a projection of the projection lens 22 on the touch pad 15 in the keyboard mode in the portable apparatus as shown in FIG. 2 is illustrated. In the embodiment, the conventional mouse control panel 4 is remained in the portable apparatus and light 231 emitted by the projection lens 22 forms a virtual keyboard 232 on the touch pad 15 with a projection area that is equal to the area of the touch pad 15.

Referring to FIG. 6, a schematic view of a projection of the projection lens 22 on the touch pad 15 in the touch-screen mode in the portable apparatus as shown in FIG. 2 is illustrated. In the embodiment, the conventional mouse control panel 4 is remained in the portable apparatus, and light 231 emitted by the projection lens 22 forms a projected image, which is the same as the screen image, on the touch pad 15 and the projected image has a projection area that is equal to the area of the touch pad 15.

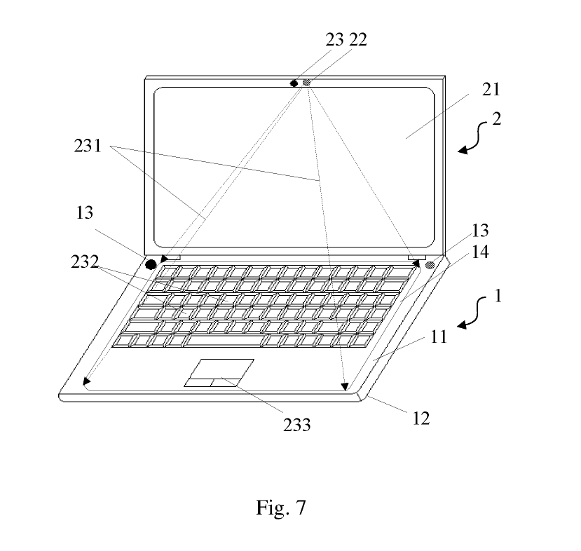

Referring to FIG. 7, a schematic view of a projection of the projection lens 22 on the touch pad 15 in the keyboard mode in the portable apparatus as shown in FIG. 4 is illustrated. In the embodiment, no conventional mouse control panel 4 is remained in the portable apparatus and the touch pad 15 covers a region where the conventional mechanical keyboard 3 and the mouse control panel 4 as shown in FIG. 1 are located. Light 231 emitted by the projection lens 22 forms a virtual keyboard 232 and a virtual mouse control panel 233 on the touch pad 15 with a projection area that is equal to the area of the touch pad 15.

Preferably, the touch-controlled board 15 in the above embodiments may be a capacitive touch pad, a resistive touch pad or an inductive touch pad.

The embodiments of the present invention have the following advantages: a switch between the keyboard mode and the touch-screen mode may be achieved by the touch pad which is disposed to the front housing of the mainframe body of the portable apparatus; the keyboard function and the screen image touch-controlled function may be achieved by allowing the corresponding projection lens to project the image matched with the switched mode onto the touch pad and processing the touch signal by the motherboard in the switched mode; and manufacturing difficulty for touch-controlled function of the portable apparatus may be further simplified and the cost is reduced. In addition, since the touch pad is not attached to the display but is disposed to the front housing of the mainframe body, replacing the conventional mechanical keyboard, a thickness of the whole portable apparatus according to the embodiments of the present invention having the touch-controlled function is not increased relative to the conventional portable apparatus having the touch-controlled function.

The portable apparatus according to the embodiments of the present invention may be a notebook computer, or a mobile equipment in which display is openable/closable to the mainframe body.

It will be understood by those skilled in the art that various changes and modifications may be made therein without departing from the spirit of the present invention. Accordingly, the present invention intends to contain these changes or modifications if they fall into the scope which is defined in the claims and their equivalents of the present invention.

1. A portable apparatus comprising a mainframe body, and a display that is coupled to the mainframe body and is configured to be openable/closable at an angle relative to the mainframe body; wherein, a touch pad and a mode switching key are provided on the mainframe body and a motherboard is provided within the mainframe body, a projection lens is provided at a frame of the display, and, the touch pad, the mode switching key and the projection lens are coupled to the motherboard; wherein:
the mode switching key is configured to switch operation modes of the motherboard and the projection lens, the operation modes comprising a keyboard mode and a touch-screen mode;
the touch pad is configured to detect a touch action and generate a touch signal;
the projection lens is configured to project a virtual keyboard onto the touch pad in the keyboard mode, and/or to project an image displayed on the display onto the touch pad in the touch-screen mode; and
the motherboard is configured to process the touch signal in line with a specified keyboard layout in the keyboard mode and control the touch pad to function as a conventional mechanical keyboard; and/or, to process the touch signal according to contents of the screen image displayed on the display in the touch-screen mode and control the touch pad to enable a screen touch control.

2. The portable apparatus as claimed in claim 1, wherein, the motherboard is further configured to control the projection lens to change a projection angle or zoom in/out the screen image to match a projection area on the touch pad with an area of the touch pad.

3. The portable apparatus as claimed in claim 1, wherein, the mainframe body comprises a front housing on which the touch pad is arranged.

4. The portable apparatus as claimed in claim 3, wherein, the touch pad is attached to the front housing by an adhesive tape.

5. The portable apparatus as claimed in claim 4, wherein, the mainframe body further comprises a buffer pad which is arranged between the front housing and the touch pad and is within a range surrounded by the adhesive tape.

6. The portable apparatus as claimed in claim 1, wherein, the touch pad comprises a capacitive touch pad, a resistive touch pad or an inductive touch pad.

7. The portable apparatus as claimed in claim 1, wherein, the projection lens is disposed at an upper frame of the display.

8. The portable apparatus as claimed in claim 1, wherein, the front housing is provided with a mouse control panel.

9. The portable apparatus as claimed in claim 1, wherein, a sensor is provided to detect the opened/closed angle of the display relative to the mainframe body.

10. The portable apparatus as claimed in claim 1, wherein, the portable apparatus further comprises a camera disposed at an upper frame of the display and a start-up key disposed on the mainframe body.
